(19) United States
(12) Patent Application Publication
(10) Pub. No.: US 2013/0162472 A1
(43) Pub. Date: Jun. 27, 2013

(54) METHOD FOR DETERMINING A PROTECTION SPACE IN THE EVENT OF TWO SIMULTANEOUS SATELLITE FAILURES

(71) Applicants: Mohamed Najim, Talence (FR); Audrey Giremus, Talence (FR); Frederic Faurie, Bordeaux (FR)

(72) Inventors: Mohamed Najim, Talence (FR); Audrey Giremus, Talence (FR); Frederic Faurie, Bordeaux (FR)

(21) Appl. No.: 13/812,843

(22) PCT Filed: Jul. 15, 2011
(86) PCT No.: PCT/EP11/62174

§ 371 Date: Jan. 28, 2013

(30) Foreign Application Priority Data
Jul. 29, 2010 (FR) 1056281

(51) Int. Cl. G01S 19/20

(52) U.S. Cl. CPC G01S 19/20
USPC 342/357.58

(57) ABSTRACT

The present invention relates to a method for determining a protection space in the event of two faulty measurements of a pseudo-range between a satellite and a receiver for receiving signals transmitted by various satellites in a radio-navigation constellation, characterized in that said method includes the steps of: (a) determining, on the basis of the pseudo-ranges measured by the receiver, a test variable representative of the likelihood of a fault; (b) estimating, for each pair of pseudo-ranges from among the pseudo-ranges measured by the receiver and from the expression of the thus-obtained test variable, a set of minimum-bias pairs detectable for a given missed detection probability; (c) expressing, for each pair of pseudo-ranges, the estimated set of detectable minimum-bias pairs in the form of an equation defining an ellipse associated with the pair of pseudo-ranges in question; (d) expressing the equation of each ellipse in parametric coordinates and expressing each detectable associated minimum-bias pair on the basis of a single parameter; (e) projecting each of the thus-parameterized detectable minimum-bias pairs over at least one subspace of R3; (f) calculating, for each subspace and for each bias pair, the maximum position error induced by the bias pair; (g) selecting, for each subspace, the maximum from among all of the calculated maximum position errors, and transmitting the results of said selection outward. The present invention also relates to an integrity-monitoring system and to a vehicle therefor.

### GENERAL TECHNICAL FIELD

The present invention relates to the field of integrity-control systems for civil and military aviation.

More precisely, it concerns a method for determining a protection volume in the case of two simultaneous satellite failures in a navigation system.

### PRIOR ART

Vehicles with satellite navigation systems are conventionally equipped with a receiver tracking N satellites, as shown in FIG. 1. Every second, the receiver must determine its position from N measurements originating from the satellites in view.

For each of these satellites, the receiver calculates an estimation of the distance separating them from the latter, called pseudorange due to the different errors by which it is flawed. Each measurement is actually perturbed by a noise measurement due especially to the wave passing through the atmosphere. However, the statistical characteristics of these measurement noises are known and these perturbations are not considered failures.

However, some satellites can present more substantial faults and provide incorrect information to the receiver, dangerously degrading the precision of the navigation solution. These satellite breakdowns, due essentially to malfunctions of the satellite clock or to problems of ephemerides, result in bias on the failing satellite measurement or the failing satellite measurements which must be detected. These biases are added to the measurements and are modelled either by echelons or by ramps evolving over time.

Even if these satellite breakdowns were rare (probability of the order of 10⁻⁴/h per satellite), navigation systems must take this risk into account, in particular in aviation where a position discrepancy can be fatal.

The aim of integrity-control systems is the detection and exclusion of satellite breakdowns. There are two distinct configurations for the integrity-control systems. When the system is coupled to a navigation support system (such as an inertial system), this means AAIM context (for Aircraft Autonomous Integrity Monitoring). When the integrity-control system operates autonomously, this means RAIM context (for Receiver Autonomous Integrity Monitoring). At a given missed detection probability, dependent on the flight phase and fixed by the International Civil Aviation Organisation (ICAO), integrity-control systems must be capable of providing a terminal on the position error of the device which may not be exceeded without detecting a malfunction in a timely manner. This is why they are known as a protection volume.

This is a cylinder centred on the estimated position of the apparatus and defined by a horizontal protecting radius and a vertical protecting radius (the height of the cylinder). It defines the volume in which it can be affirmed that the apparatus is really close to the missed detection probability.

Until recently, the single hypothesis of a single satellite failure was enough to satisfy ICAO requirements. But with the next deployment of novel constellations of satellites (Galileo in 2014 and modernised GPS in 2013), as well as tightening of ICAO requirements (missed detection probability less than one in ten million), integrity-control systems today must take into account an increase in the number of available satellite measurements. In particular, they must be able to process several simultaneous satellite breakdowns, an event whereof the occurrence probability is no longer negligible with respect to ICAO requirements.

Various methods have been proposed to date for providing a solution to the problem of calculating the protecting radii.

Whether this is in a RAIM context or an AAIM context, the integrity-control systems use one or more hypothesis tests for detecting one or more possible faults among the measurements available. These hypothesis tests are based on test variables compared to thresholds for detecting the presence of faults. These test variables are constructed from one or more estimations of the navigation solution and optionally of the measurements received. The navigation solution can be estimated for example by a Kalman filter or by an estimator in terms of least squares.

Determining the protection volume translating performances of the integrity-control system is based on the statistics of the different test variables used. The protecting radii associated with the most used algorithms for detecting a satellite failure are mentioned in the document “Fde using multiple integrated gps/inertial Kalman filters in the presence of temporally and spatially correlated ionospheric errors”, Proceedings of ION GPS (2001), by K. Vanderwerf.

The diagram of an example of a method for determining a protection volume in the case of a single satellite failure is illustrated by FIG. 3. By way of definition, the protecting radii must be independent of the measurements and therefore predictable for a given place and time. As mentioned previously, the method for failure detection used during step 100 is based on one or more hypothesis tests. For clarity, the case of a single hypothesis test based on a test variable, noted Tₜ, is considered, whereof the statistical distribution is known and for which a decision threshold can be determined for a given probability of false alarm, noted P_{fa}. For a given missed detection probability P_{md}, step 200 defines a minimum bias detectable for each measurement i ε[1, N]; this bias is noted hereinbelow as b_{min,i}. The minimum detectable bias b_{min,i} represents the minimum amplitude of a bias appearing on the measurement i which the hypothesis test can detect for a given missed detection probability. It should be noted that b_{min,i} depends not on measurements but on the geometry of the satellite i as well as the variance in noise measurement. The impact of this bias on the estimation of the navigation solution is then evaluated during projection step 300 on the position error. The result is a upper bound on the estimation error, noted HPL(i) for the horizontal error and VPL(i) for the vertical error, which the method may not exceed without detecting a failure on the measurement i with the missed detection probability P_{md}:

HPL(i)=μ_{H}⁽ⁱ⁾\tilde{b}_{min,t}

VPL(i)=μ_{V}⁽ⁱ⁾\tilde{b}_{min,i}
with μ_{H}⁽ⁱ⁾ and μ_{V}⁽ⁱ⁾ the projection matrices of the bias of the measurement on the horizontal and vertical plane of the navigation solution respectively.

The protecting radii under the assumption of a single failure at the instant t are defined during step 400 by selecting the worst hypothesis, that is, the maximum value according to the N measurements for HPL and for VPL.

It should be noted that in the case of a single failure the minimum detectable bias for each potentially faulty measurement is a scale which can therefore easily be projected again onto the position error. In the case of a double failure, an infinity of bias pairs is detectable for a missed detection probability.

There is currently no method for determining a protection volume in the case of a simultaneous double satellite failure.

### PRESENTATION OF THE INVENTION

The aim of the present invention is to resolve these difficulties by proposing a solution for determining a protection volume in the case of a simultaneous double satellite failure in a constellation of about fifteen satellites, without the need for calculating power substantially greater than that of current onboard systems, and therefore without additional cost.

With this taken into account of a larger number of possible incidents, the invention allows increased aerial security, considering cases which to date would have resulted in aerial catastrophes.

In addition, another aim of the invention is to arrive at this objective by proposing a method which can be integrated into both an AAIM context and a RAIM context. There is therefore total adaptability.

The present invention therefore relates to a method for determining a protection volume in the event of two faulty measurements of pseudorange between a satellite and a receiver receiving signals transmitted by different satellites of a radio-positioning constellation, characterised in that it comprises steps of:

(a) Determining a test variable representative of the likelihood of a fault as a function of the pseudoranges measured by the receiver;

(b) Estimating, for each pair of pseudoranges among the pseudoranges measured by the receiver, the set of detectable minimum-bias pairs for a given missed detection probability, from the expression of the test variable obtained;

(c) Expressing, for each pair of pseudoranges, the set of detectable minimum-bias pairs estimated in the form of an equation defining an ellipse associated with the pair of pseudoranges in question;

(d) Expressing the equation of each ellipse in parametric coordinates and expression of each detectable minimum-bias pair associated as a function of a single parameter;

(e) Projecting each detectable minimum-bias pair accordingly parameterised onto at least one subspace of R³;

(f) Calculating, for each subspace and each bias pair, the maximal position error caused by the bias pair;

(g) Selecting, for each subspace, the maximum among all maximal position errors calculated and transmission outwards of the results of this selection.

According to other advantageous and non-limiting characteristics of the invention:

the subspace or the subspaces selected at step (e) are additional in R³, in such a way that the position errors maximum define the dimensions of a volume;

step (e) comprises projection on the horizontal plane and projection on the vertical axis;

the test variable generated at step (a) follows a X² distribution with N degrees of freedom;

the coefficients of the ellipse equation determined at step (c) are expressed as a function of the missed detection probability and of the variance in noise measurement;

step (d) comprises the projection of the ellipse on an eigenvector basis;

the parameterization of step (d) is polar parameterization, the single parameter being an angular coordinate;

an estimation error is obtained at each projection at step (e) of a bias pair on a subspace of R³, this estimation error being a vector of the same dimension as the subspace expressed only as a function of the single parameter obtained at step (d), noted θ;

the maximal position error caused is calculated at step (f) by adopting the standard of the vector estimation error and deriving therefrom relative to θ.

According to a second aspect, the invention relates to a integrity-control system, comprising data-processing means, associated with a receiver receiving signals transmitted by different satellites of a radio-positioning constellation and supplying the system with pseudoranges measured between satellites of said constellation and the receiver on which the means execute a method according to the first aspect of the invention, on completion of which a signal is transmitted to an interface of the system.

According to other advantageous and non-limiting characteristics of the invention:

the system is coupled to an inertial navigation device according to an AAIM context.

The invention finally relates to a vehicle equipped with a system according to the second aspect of the invention.

### PRESENTATION OF THE FIGURES

Other characteristics and advantages of the present invention will emerge from the following description of a preferred embodiment. This description will be given in reference to the attached diagrams, in which:

FIG. 1 is a diagram of a constellation of satellites sending data to a plane in its protection volume;

FIG. 2 is a diagram of an embodiment of an integrity-control system according to the invention connected to a receiver;

FIG. 3 is a diagram of a known method for determining a protection volume in the case of a single faulty measurement of pseudorange between a satellite and a receiver;

FIG. 4 is a diagram of an embodiment of the method for determining a protection volume in the event of two faulty measurements of pseudorange between a satellite and a receiver according to the invention;

FIG. 5 is a diagram representing steps of an embodiment of the method for determining a protection volume in the event of two faulty measurements of pseudorange between a satellite and a receiver according to the invention;

FIG. 6 is a graphic illustrating an ellipse used during a step of an embodiment of the method for determining a protection volume in the event of two faulty measurements of pseudorange between a satellite and a receiver according to the invention;

FIG. 7 is a graphic illustrating the position error calculated during a step of an embodiment of the method for determining a protection volume in the event of two faulty measurements of pseudorange between a satellite and a receiver according to the invention.

### DETAILED DESCRIPTION

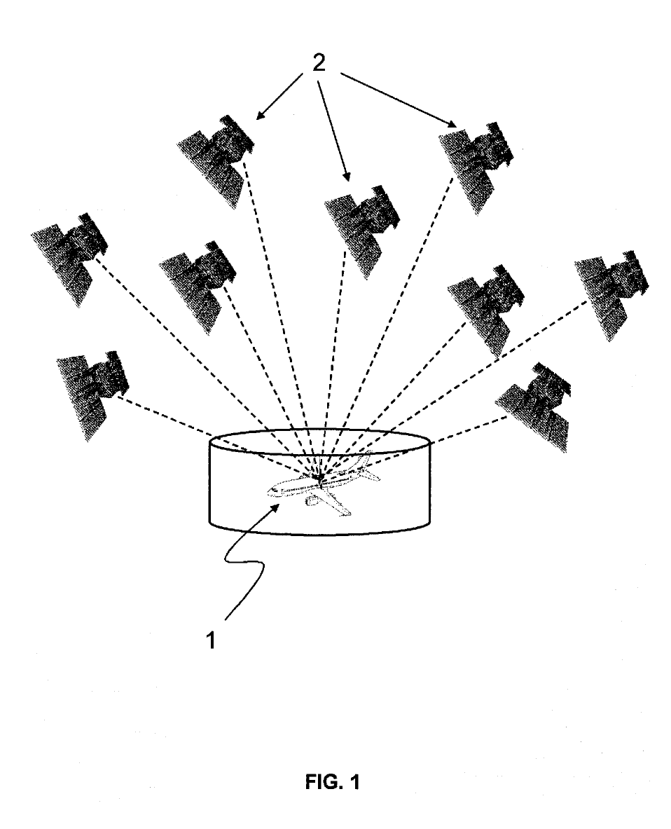

As shown in FIG. 1 then 2, a vehicle 1 such as a plane, equipped with a receiver 10 of GNSS type, receives electromagnetic signals (generally microwaves) originating from a plurality of satellites 2 forming a radio-positioning constellation.

Each satellite 2 is equipped with a high-precision clock, and the receiver 10 precisely knows their position due to ephemerides stored in a memory 13. Because of the clock, the time can be measured precisely by a signal for creating the trajectory between the satellite 2 and the receiver. For this, the receiver 10 uses a correlation technique to estimate the propagation time of the satellite signal, between emission and receipt. Knowing the speed of light, at which the wave of the signal moves, a computer 11 comprised in the receiver 10 multiplies the duration measured by this speed, providing the pseudorange which separates it from the satellite 2, as explained previously. The fact that the distance is not known with certainty especially because of the noise measurement causes some uncertainty as to the position of the vehicle 1. The cylinder illustrated in FIG. 1 corresponds to the volume centered on the estimated position in which the presence of the vehicle is guaranteed within a missed detection probability.

In general, the navigation measurement equation by satellite among a constellation of N satellites is shown as:

\tilde{Y}ₜ=hₜ(rₜ,b_{H,t})+εₜ+bₜ

where, at the instant t:

\tilde{Y}ₜ is the vector containing the N measurements formed by the receiver, that is, the N pseudoranges calculated according to the principle hereinabove with each of the N satellites,

εₜ is the vector of N supposed Gaussian and centred measurement noises,

bₜ is the vector of N bias impacting the N measurements whereof several components can be non zero,

the i^{th} component of the vector function hₜ(.) represents the geometric distance separating the receiver from the i^{th} satellite, perturbed by the clock bias. It is expressed as follows: hₜⁱ(rₜ,b_{H,t})=∥rₜ−rₜⁱ∥+b_{H,t} where is the clock bias, and rₜ and rₜⁱ designate the position in Cartesian coordinates of the receiver and of the i^{th} satellite, respectively. E_{N} is the set such that its i^{th} element E_{N}ⁱ,i ε[1, N] is the i^{th} satellite measurement.

By linearising around an adequately selected point, the measurement equation becomes Yₜ=HₜXₜ+εₜ+bₜ

where, at the instant t:

Xₜ is the status vector containing the position of the receiver,

Hₜ is the linearised observation matrix.

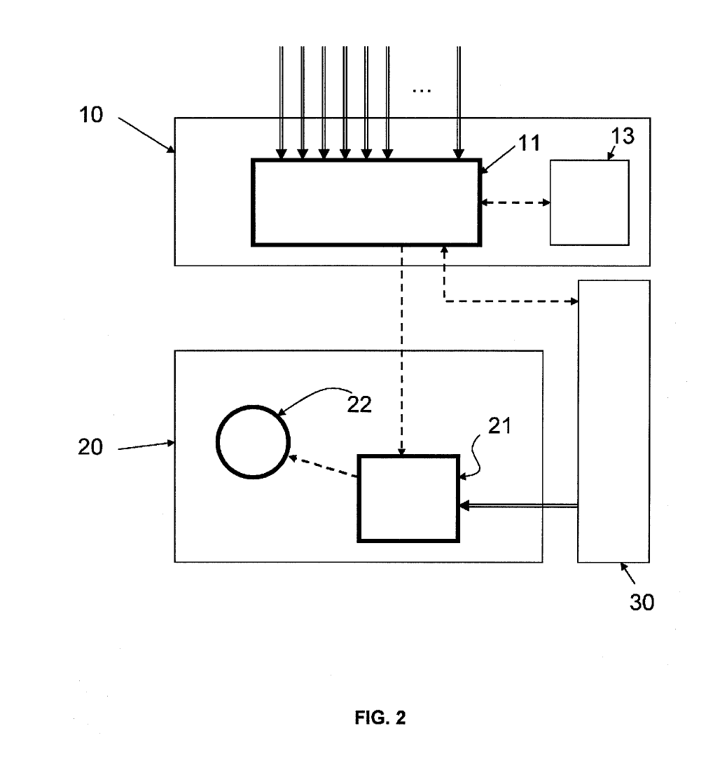

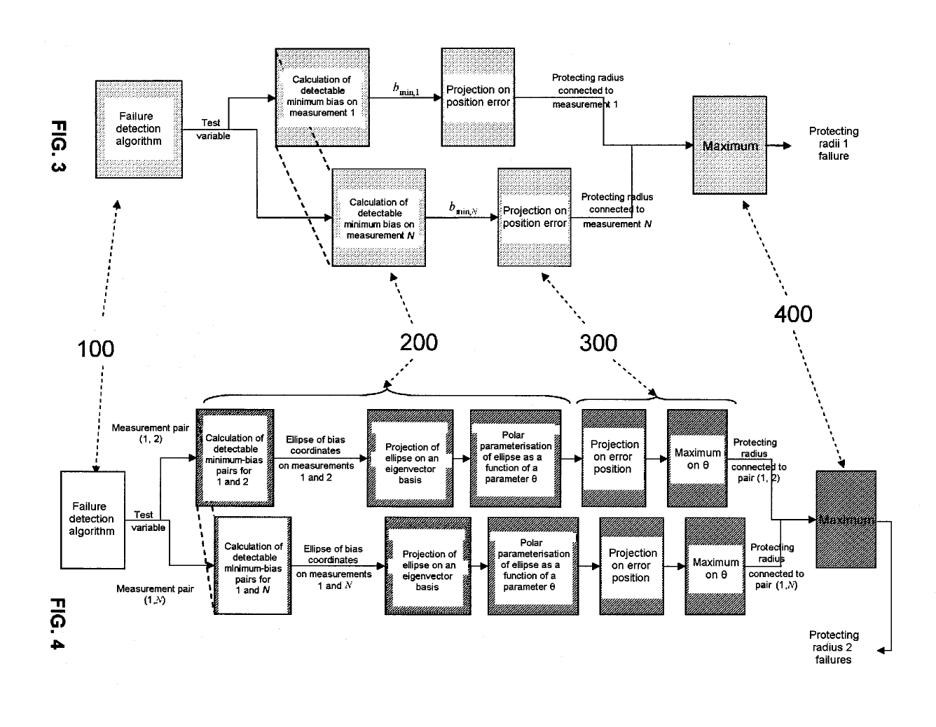

The method for determining a protection volume according to the invention is executed by an integrity-control system 20, also illustrated in FIG. 2, connected to the receiver 10. This system 20, comprising data processing means 21 (a computer), receives and processes the N satellite measurements provided by the receiver 10. Throughout the description i^{th} satellite measurement will designate the pseudorange measured between the i^{th} satellite of the observed radio-positioning constellation and the receiver 10, calculated by a computer 11 which this receiver 10 comprises.

After processing, the characteristics of the determined protection volume are transmitted to an interface 22 to be exploited especially by the pilot, or by other navigation instruments.

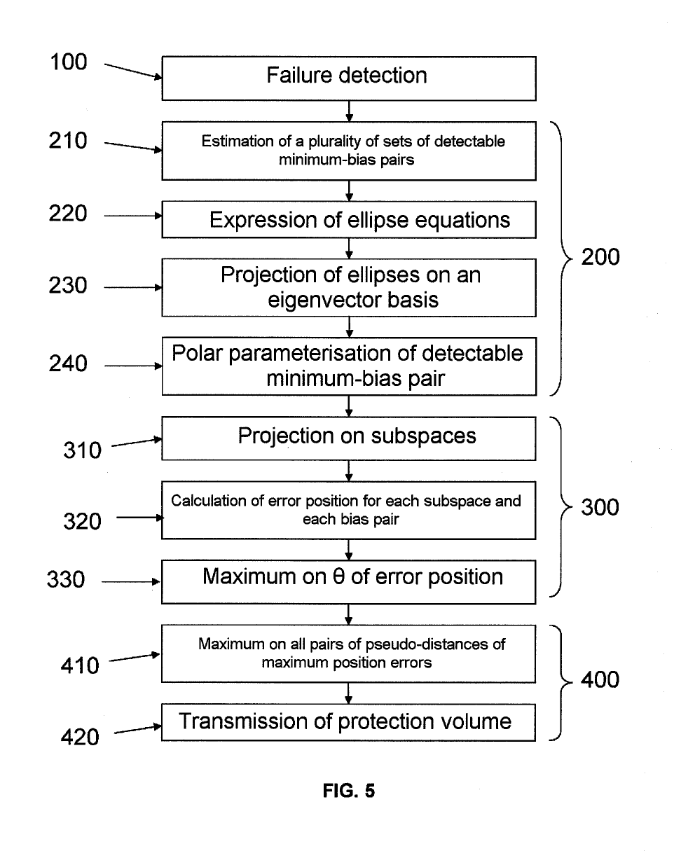

The steps of an embodiment of the method for determining a protection volume according to the invention are represented in FIG. 4, and more particularly in FIG. 5.

### Detection of Failure

Determining a protection volume in the case of two potentially faulty measurements starts similarly to methods known by a first step 100 for failure detection from N satellite measurements.

For this, the computer 21 of the integrity-control system 20 determines a test variable Tₜ, which as explained previously, is representative of the likelihood of a failure, for example if it exceeds a threshold dependent on a given probability of false alarm, noted P_{fa}.

For example, in the case of a RAIM algorithm based on the residue method, the test variable used to decide the presence of a failure is advantageously:

$${T}_{t} = \frac{{w}_{t}^{T} {w}_{t}}{{σ}^{2}} ,$$

where wₜ is the residue vector. It is defined as follows:

$${w}_{t} = {Z}_{t} - {H}_{t} {\hat{X}}_{t}^{LS} = \underbrace{( {I}_{N \times N} - {{H}_{t} ( {H}_{t}^{T} {H}_{t} )}^{- 1} {H}_{t}^{T} )}_{{G}_{t}} {Z}_{t} .$$

The test variable advantageously follows a X₂ (chi-squared) distribution with N degrees of freedom, as is the case in this example.

### Pairs of Minimum Detectable Bias

Once this variable is determined, during a step 200 the method will express a plurality of detectable minimum-bias pairs. This plurality of detectable minimum-bias pairs corresponds to the hypotheses of possible failures. So, in the prior art, N possible failures of a single satellite measurement were considered.

The method according to the invention envisages the

$${C}_{N}^{2} = \frac{N ( N + 1 )}{2}$$

simultaneous failures of two satellite measurements. During a first sub-step 210, the system 20 estimates for each pair of pseudoranges measured the set of possible pairs of minimum detectable bias for a given missed detection probability P_{md}.

The difficulty is that moving to two-dimension, an infinity of bias pairs is detectable for a given missed detection probability, whereas there is one single solution in the case of a single satellite failure.

To estimate the set of bias pairs b_{min,i} and b_{min,j}, the system 20 recalculates the test variable Tₜ by considering that the bias vector bₜ has two non-zero components corresponding to the faulty measurements.

In the case of our example of residue, in the absence of satellite failure, the bias vector is entirely zero and the residue vector can be put in the form wₜ=Gₜεₜ.

The test variable normally verifies

$${T}_{t} = \frac{{ɛ}_{t}^{T} {G}_{t} {ɛ}_{t}}{{σ}^{2}}$$

(this result is obtained in noting that Gₜ^{T}Gₜ=Gₜ²=Gₜ) and it follows a X₂ distribution with N-4 degrees of freedom.

If one of the components at least of the bias vector bₜ is non-zero then the test variable follows a X₂ distribution decentred by non-centrality parameter λ and with N-4 degrees of freedom. Given that the i^{th} and the j^{th} measurement are in failure, bₜ is of the form bₜ=[0, . . . ,bᵢ, . . . ,bⱼ, . . . ,0]. The test variable can be connected to its parameter of non-centrality:

$$λ = \frac{{b}^{T} Gb}{{σ}^{2}} = \frac{G ( i , i )}{{σ}^{2}} {b}_{i}^{2} + \frac{G ( j , j )}{{σ}^{2}} {b}_{j}^{2} + 2 \frac{G ( i , j )}{{σ}^{2}} {b}_{i} {b}_{j} ,$$

with G(l,m) the element situated on the line and the column m of the matrix G.

Corresponding to a probability P_{md} and a given number of degrees of freedom is a value of λ and therefore to a set of values bᵢ and bⱼ as per the preceding equation. These are minimum detectable biases.

The following step 220 comprises modifying this equation to make of it an ellipse equation of the form

α(b_{min,i})²+β(b_{min,j})²+γb_{min,i}b_{min,j}=1

with α, β and γ coefficients dependent advantageously especially on the missed detection probability P_{md} and on the variance in noise measurement. This is done by identification of the coefficients of the polynom by the computer 21.

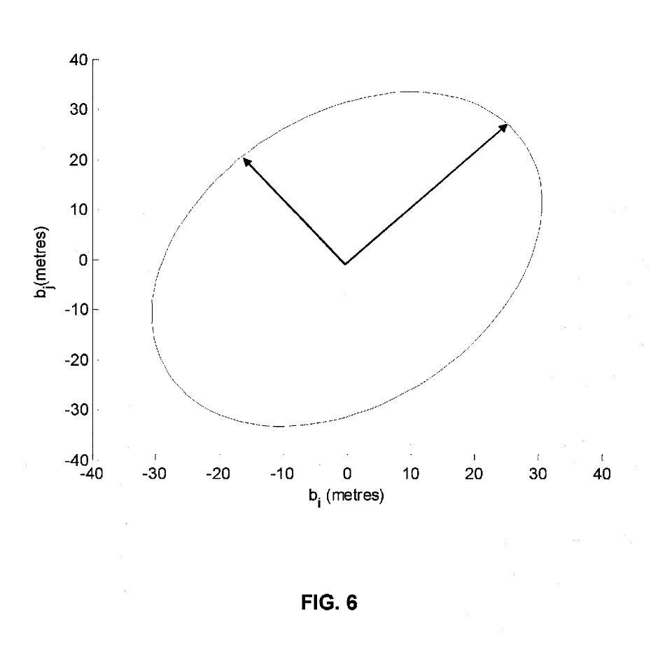

This ellipse, seen in FIG. 6, is such that the bias pairs located outside the ellipse are detected with a missed detection probability less than P_{md}.

In particular equations of the residue method give for example

$$α = \frac{G ( i , i )}{{λσ}^{2}} , \\ β = \frac{G ( j , j )}{{λσ}^{2}}$$

$$et$$

$$γ = 2 \frac{G ( i , j )}{{λσ}^{2}}$$

The protecting radii are by definition constructed from the worst impact of bias defined by the ellipse. Due to the infinity of detectable bias pairs, their calculation needs an optimisation problem to be resolved under difficult conditions.

For this the computer 21 will recalculate the equation of each ellipse in parametric coordinates, advantageously by projecting it on an eigenvector basis during a step 230.

In fact, the general ellipse equation presented earlier can be rewritten in matrix form:

[b_{min,i},b_{min,j}]M[b_{min,i},b_{min,j}]^{t}=1 with [.]^{T} designating the transposed vector or a matrix and

$$M = [ \begin{matrix}α & γ \\ γ & β\end{matrix} ] .$$

The matrix M is symmetrical and diagonalisable by the computer 21 on an eigenvector basis as follows:

M=PDP^{T} where D is a diagonal matrix

$$D = [ \begin{matrix}{D}_{11} & 0 \\ 0 & {D}_{22}\end{matrix} ] .$$

By using this decomposition, the preceding equation can be in the form:

[b_{min,i},b_{min,j}]PDP^{T}[b_{min,i},b_{min,j}]^{T}=1

That is,

$$[ {\tilde{b}}_{min , i} , {\tilde{b}}_{min , j} ] {D [ {\tilde{b}}_{min , i} , {\tilde{b}}_{min , j} ]}^{T}$$

$$with \\ [ \begin{matrix}{\tilde{b}}_{min , i} \\ {\tilde{b}}_{min , j}\end{matrix} ] = {P}^{T} [ \begin{matrix}{b}_{min , i} \\ {b}_{min , j}\end{matrix} ] .$$

With this marker change, the equation describing the ellipse of the minimum detectable biases for a given missed detection probability P_{md} becomes:

$${( \frac{{\tilde{b}}_{min , i}}{a} )}^{2} + {( \frac{{\tilde{b}}_{min , j}}{b} )}^{2} = 1 ,$$

with a and b of the parameters dependent on D and M and corresponding to the semi-axes of the ellipse, as shown in FIG. 6.

Projection of the ellipse on an eigenvector basis cancelled the cross term between b_{min,i} and b_{min,j} of the equation.

The determination by the computer 21 of the parameters a and b during step 240 from the matrices calculated at the preceding step expresses bias in parametric coordinates, hence transformation of the bidimensional problem into a one-dimensional problem:

$$\{ \begin{matrix}{\tilde{b}}_{min , i} = a cos θ , \\ {\tilde{b}}_{min , j} = b sin θ .\end{matrix}$$

Therefore, each detectable minimum-bias pair for a missed detection probability is a function of a single parameter θ, here a polar coordinate.

### Position Errors

To obtain the protecting radii, it remains to project onto the position error the bias pairs located on the contour of the ellipse and find the maximal position error, that is, the most unfavourable. This approach is conservative as the pairs inside the ellipse lead to a lesser position error than those located on the contour. This is step 300.

It starts with a sub-step 310 for projection of each detectable minimum-bias pair on at least one subspace of R³. In fact the ellipse is a curve in a three-dimensional space. To determine a protection volume, the dimensions of this volume have to be determined, and therefore different projections have to be made. The subspace of R³ is any vector subspace in single or dual dimension, that is, all the planes and straight lines. By way of advantage, these subspaces are selected such that they are additional: for example, a plane and a non-coplanar straight line, three non-colinear straight lines in pairs, two non-parallel nor combined planes, etc. In this way, the space engendered by these subspaces is in three dimensions, and therefore defines volume.

As it is standard, the protection volumes are generally cylinders of horizontal base, defined by a radius and a height. For such a volume it suffices advantageously to adopt the horizontal plane as first subspace, and a vertical straight line as second subspace. The maximum position error on the plane will be the radius of the base, and the maximum position error on the straight line will be the height of the cylinder. The person skilled in the art can however adapt the invention to other geometries of protection volumes.

This sub-step 310 is performed by the computer 21 by means of a matricial product of the matrix of the bias by a marker change matrix.

In this preferred embodiment with cylindrical geometry, the horizontal estimation errors (in the plane) and vertical estimation errors (on the straight line), noted respectively ΔX_{H}^{(i,j)} and ΔX_{V}^{(i,j)}, engendered by the possible bias pairs (b_{min,i}, b_{min,j}) are expressed as:

$$Δ {X}_{H}^{( i , j )} = {μ}_{H}^{( i , j )} [ \begin{matrix}{b}_{min , i} \\ {b}_{min , j}\end{matrix} ]$$

$$and$$

$$Δ {X}_{V}^{( i , j )} = {μ}_{V}^{( i , j )} [ \begin{matrix}{b}_{min , i} \\ {b}_{min , j}\end{matrix} ]$$

with μ_{H}^{(i,j)}, and μ_{V}^{(i,j)} the bias projection matrices on the measurements i and j on the horizontal plane and the vertical axis of the navigation solution respectively.

In fact, for an embodiment including an estimator of least squares type, estimation of the vector Xₜ in terms of least squares verifies: \hat{X}ₜ^{t,S}=\tilde{H}ₜZₜ=\tilde{H}ₜ(HₜXₜ+εₜ+bₜ)=Xₜ+\tilde{H}ₜ(εₜ+bₜ). So, if only the estimation error connected to the bias is considered,

$$\underbrace{{\hat{X}}_{t}^{LS} - {X}_{t}}_{Δ {X}_{t}} = {\tilde{H}}_{t} {b}_{t} ,$$

with \tilde{H}ₜ=Hₜ(Hₜ^{T}Hₜ)⁻¹Hₜ^{T}.

In this embodiment, μ_{H}^{(i,j)} and μ_{V}^{(i,j)} are therefore sub-matrices of \tilde{H}ₜ formed from the lines corresponding to the coordinates in the horizontal plane and its columns i and j for the first, and of the line corresponding to the vertical axis and its columns i and j for the second. The estimation errors are therefore vectors of one or two dimensions. Here, for the horizontal parameter, the subspace on which the ellipse is projected, is a plane, therefore in two dimensions, which is why ΔX_{H}^{(i,j)} is a vector.

The system 20 calculates the position errors caused by the bias pair during a step 320 for each subspace and each bias pair from the estimation errors.

Hereinbelow, only the position error on the horizontal plane is presented. However, the same approach is made for the vertical position error. Advantageously this step 320 is resolved by calculation of the standard of the vector estimation error.

If for example the standard is selected in terms of the classic scale product (∥ū∥={square root over (\vec{u}·ū) by placing M_{H}=P^{T}(μ_{H}^{(i,j)})^{T} μ_{H}^{(i,j)}P, the position error on the horizontal plane caused by the pair (b_{min,i}, b_{min,j}) is calculated by the computer 21 by way of the equation:

$$\vert \vert Δ {X}_{H}^{( i , j )} \vert \vert = \sqrt{{M}_{H} ( 1 , 1 ) {a}^{2} {cos}^{2} θ + {M}_{H} ( 2 , 2 ) {b}^{2} {sin}^{2} θ + 2 {M}_{H} ( 1 , 2 ) ab sin θ cos θ} ,$$

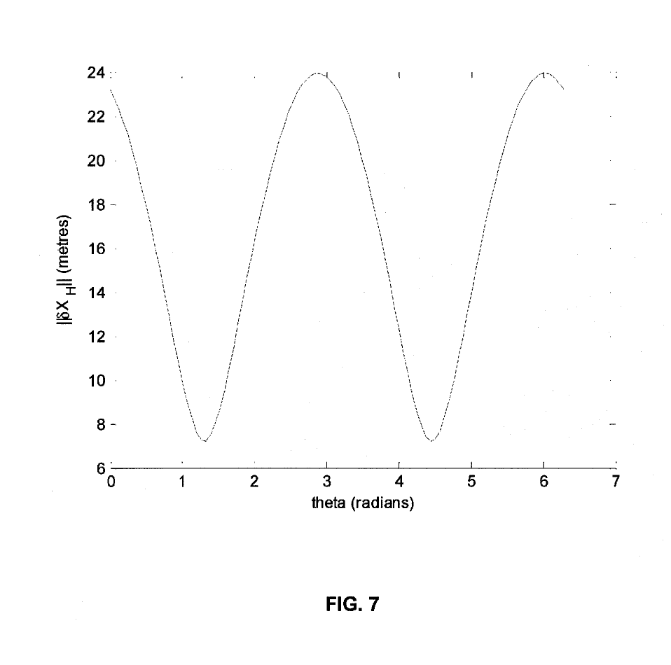

with M_{H}(l,m) the element of the line l and of the column m of the matrix M_{H}. This function of θ is illustrated in FIG. 7.

The horizontal protecting radius is obtained at step 330 by searching for the maximum relative to the parameter θ of the position error defined previously. This function has several local extremas, as seen in FIG. 7; there are four here, for example. To obtain this, the computer 21 will advantageously derive the function position error as a function of θ, and select the values where the derivative is cancelled. After calculation, the solutions verify:

$$θ = \frac{1}{2} arctan ( \frac{2 {abM}_{H} ( 1 , 2 )}{{b}^{2} {M}_{H} ( 2 , 2 ) - {a}^{2} {M}_{H} ( 1 , 1 )} ) + k \frac{π}{2} ,$$

with k a whole number. p The computer 21 recalculates the value of the position error for each of these extrema and selects the maximum. If θ*_{H} is noted as the set of values of θ which corresponds to the extrema of the horizontal error position function (each θ corresponding to a pair of b_{min,i} and b_{min,j}) this gives

$$H P {L}^{( i , j )} = {max}_{θ ∈ {θ}_{H}^{″}} \vert \vert Δ {X}_{H}^{( i , j )} \vert \vert .$$

This then is the maximum position error caused by the bias for the pertinent pair (i,j)ε[1, N]×[1,N] et i≠j of satellite measurements.

### Protecting Radii

The maximal error is calculated for each of the measurement pairs. During a step 410 the system 20 obtains the protecting radii in the case of two failures at an instant by selecting the maximum of the errors calculated for all these pairs;

$$H P {L}_{( 2 )} = {max}_{i , j} ( H P {L}^{( i , j )} )$$

$$with \\ ( i , j ) ∈ [ 1 , N ] \times [ 1 , N ] , \\ i \neq j .$$

The same reasoning can be applied for the vertical axis. The method provides the values of the protecting radii to onboard systems during the ultimate step 420.

### Systems and Vehicles

As described previously, the integrity-control system 20 shown in FIG. 2 is connected to a receiver 10, type GNSS, configured to receive measurements originating from N satellites. The receiver 10 comprises data-processing means 11 and a memory 13. They transfer the measurements conventionally to onboard instruments to allow exploitation of geolocation data calculated from the satellite measurements, as well as to the system 20 which will control them.

The system 20 also comprises data-processing means 21, by which it will be able to execute a method according to the first aspect of the invention, and an interface 22. This interface 22 can take numerous forms such as a monitor, a loudspeaker, or simply be connected to the onboard instruments and generally serves to define a guaranteed positioning zone around the apparatus 1. For example, on a pilot monitor, it will designate a volume in which a collision is possible. In addition, aerial corridors are defined for the planes. The protection volume can be used to keep a plane inside the aerial corridor with certainty.

In addition, the system 20 can advantageously be coupled to a navigation system 30, such as an inertial system, supplying the means 21 for processing navigation data which can be used during the failure detection step to be in an AAIM context.

The invention also relates to a vehicle 1, in particular a plane, equipped with such an integrity-control system 20, allowing it an unequalled level of security, since it is no longer aware of the possibility of having two simultaneous satellite breakdowns, a case not treated previously, and which might result in an aerial catastrophe if an excessively limited protection volume was calculated due the possibility of a second faulty measurement. The invention is not however limited to planes and can be fitted to any aircraft, or even a ship or terrestrial vehicle, even if the integrity requirement of satellite measurements is not as crucial.

1. A method for determining a protection volume in the event of two faulty measurements of pseudorange between a satellite and a receiver receiving signals transmitted by different satellites of a radio-positioning constellation, characterised in that it comprises steps of:
(a) Determining a test variable representative of the likelihood of a fault as a function of the pseudoranges measured by the receiver;
(b) Estimating, for each pair of pseudoranges among the pseudoranges measured by the receiver, the set of detectable minimum-bias pairs for a given missed detection probability, from the expression of the test variable obtained;
(c) Expressing, for each pair of pseudoranges, the set of detectable minimum-bias pairs estimated in the form of an equation defining an ellipse associated with the pair of pseudoranges in question;
(d) Expressing the equation of each ellipse in parametric coordinates and expressing each associated detectable minimum-bias pair as a function of a single parameter;
(e) Projecting each detectable minimum-bias pair accordingly parameterised on at least one subspace of R³;
(f) Calculating, for each subspace and each bias pair, the maximal position error caused by the bias pair;
(g) Selecting, for each subspace, the maximum from among all of the position maximal errors calculated and transmitting the results of said selection outwards.

2. The method according to the preceding claim, characterised in that the subspace or the subspaces selected at step (e) are additional in R³, in such a way that the maximal position errors define the dimensions of a volume.

3. The method according to the preceding claim, characterised in that step (e) comprises projection on the horizontal plane and projection on the vertical axis.

4. The method according to any one of the preceding claims, characterised in that the test variable generated at step (a) follows a X² distribution with N degrees of freedom.

5. The method according to any one of the preceding claims, characterised in that the coefficients of the ellipse equation determined at step (c) are expressed as a function of the probability of missing detection and of the variance in noise measurement.

6. The method according to any one of the preceding claims, in which step (d) comprises projection of the ellipse on an eigenvector basis.

7. The method according to any one of the preceding claims, in which parametrisation of step (d) is polar parametrisation, the single parameter being an angular coordinate.

8. The method according to any one of the preceding claims, in which an estimation error is obtained at each projection at step (e) of a bias pair on a subspace of R³, this estimation error being a vector of the same dimension as the subspace expressed only as a function of the single parameter obtained at step (d), noted θ.

9. The method according to the preceding claim, in which the maximal position error caused is calculated at step (f) by adopting the standard of the vector estimation error and deriving it therefrom relative to θ.

10. An integrity-control system (20), comprising data-processing means (21), linked to a receiver (10) receiving signals transmitted by different satellites of a radio-positioning constellation and supplying the system (20) with pseudoranges measured between satellites of said constellation and the receiver (10) on which the means (21) execute a method according to any one of the preceding claims, on completion of which a signal is transmitted to an interface (22) of the system (20).

11. A system according to the preceding claim, characterised in that it is coupled to an inertial navigation device (30) according to an AAIM context.

12. A vehicle (1) equipped with a system according to any one of claims 10 to 11.
